(19) United States
(12) Patent Application Publication
(10) Pub. No.: US 2018/0034220 A1
(43) Pub. Date: Feb. 1, 2018

(54) Retractable Recessed Electrical Outlet and Data Port Assembly

(71) Applicants: ERIC FORTI, Boynton Beach, FL (US); Ramesh Nimmagadda, Boca Raton, FL (US)

(72) Inventors: ERIC FORTI, Boynton Beach, FL (US); Ramesh Nimmagadda, Boca Raton, FL (US)

(21) Appl. No.: 15/727,721

(22) Filed: Oct. 9, 2017

Related U.S. Application Data
(63) Continuation-in-part of application No. 14/943,737, filed on Nov. 17, 2015.

(51) Int. Cl. H01R 25/00; H02G 3/14; H01R 13/56; H01R 24/76; H02G 3/18

(52) U.S. Cl. CPC H01R 25/006; H01R 24/76; H02G 3/18; H01R 13/56; H02G 3/14

(57) ABSTRACT

The present invention relates to a retractable electrical receptacle assembly which is installed into a standard electrical box and is substantially flush to a mounting surface into which the electrical box is mounted. The invention may be mounted into a wall, floor, countertop or work surface. The invention can be installed as part of new electrical service or can replace an existing outlet by wiring into an existing electrical box. The invention includes at least one operative socket in the closed position and at least one additional operative socket in the open position.

### CROSS-REFERENCE TO RELATED APPLICATIONS

This application repeats a substantial portion of prior application Ser. No. 14/943,737 filed Nov. 17, 2015 which claims the benefit of PCT/US2015/015682 filed Feb. 12, 2015 and adds additional disclosure not presented in the prior applications, it may constitute a continuation-in-part of the prior application.

### BACKGROUND OF THE INVENTION

### Field of the Invention

The invention relates to an electrical outlet assembly. More particularly, the invention relates to a retractable electrical outlet assembly that fits into standard electrical outlet box which electrical outlet assembly comprises electrical outlet sockets available for use in the closed position and opens to expose additional electrical outlet sockets for use in the open position.

### Description of Related Art

In today's environment, more and more electronic devices and appliances are in use which require electrical outlets and data ports for providing power to, and recharging, such devices. Standard electrical outlets are most commonly found in duplex and quadraplex configurations which limits the number of devices or appliances that can be plugged in at any one time. Changing an existing electrical outlet into an outlet with additional sockets is expensive and requires installation of a larger outlet box, changes to the wall and electrical wiring. In many instances, there may not be room in the wall to accommodate the larger outlet box.

The problem with limited outlet sockets has been overcome in the past by power strips or multi-outlet converters with multiple sockets that plug into an existing outlet. These outlet strips and converters are cumbersome with the power strips hanging from a cord and the converters protruding out from the outlet. Therefore, it is desirable to provide an electrical outlet and data port assembly that provides additional outlets while still fitting into existing standard electrical boxes. More particularly, it is desirable to provide an electrical outlet and data port assembly that has outlets and data ports in the closed position and opens to expose additional electrical outlet sockets and data ports in the open position.

There have been a number of recessing telescoping electrical receptacle assemblies disclosed which when in the service position the electrical outlet sockets are exposed and when in the closed position a closure plate is flush with the building member to which the assembly is attached. U.S. Pat. No. 2,811,574 issued Oct. 29, 1957 to Guerrero, U.S. Pat. No. 2,811,575 issued Oct. 29, 1957 to Guerrero, U.S. Pat. No. 3,433,886 issued Mar. 18, 1969 to Myers and U.S. Pat. No. 3,794,956 issued Feb. 26, 1974 to Dubreuil each describe a telescoping receptacle assembly with a seal to prevent the introduction of fluids.

U.S. Pat. No. 6,127,630 issued Oct. 3, 2000 to McKenzie, describes a recessible electrical receptacle with an open-ended housing mounted to a building member with a hinged closure pivotable from a service position to a recessed position flush with the building member. The socket of the electrical receptacle is only accessible in the open or service position.

A number of patents and published applications have been directed at providing recessible power outlets and data ports mounted to work surfaces. U.S. Pat. No. 4,551,577 issued Nov. 5, 1987 to Byrne describes a retractable power center which includes a rectangular housing formed in a work surface with a clamping arrangement to secure the housing to the work surface. The power outlets are arranged inside the rectangular housing. U.S. Pat. No. 5,231,562 issued Jul. 27, 1993 to Pierce describes a desktop wire management system with outlet receptacles mounted on a module cover mounted over the receptacles in a removable storage compartment. U.S. 2008/0200050 A1 published Aug. 21, 2008 describes an expandable power and data distribution center capable of pivoting between open and closed positions with the sockets exposed when in the open position.

None of the above references, taken alone or in combination, are seen as teaching or suggesting the presently claimed retractable electrical and data port outlet assembly which assembly has socket accessible for operative use in the closed position and provides additional sockets for operative use in the open positions.

### BRIEF SUMMARY OF THE INVENTION

The present invention overcomes the above limitation of the above inventions by providing a retractable electrical receptacle assembly which is installed into a standard electrical box and is substantially flush or parallel to a mounting surface into which the electrical box is mounted. The invention can be installed into an outlet box with a volume as small as 18 sq. in. A typical 18 sq. in. volume electrical outlet box generally measures 3″ long×2″ wide×2½″ deep. The invention may be directly wired to electrical service inside an electrical box installed into a wall, floor, countertop or work surface. It is understood that the electrical outlet box is not part of the invention and the invention can be installed in any appropriate sized outlet box. The invention can be installed as part of new electrical service or can replace an existing outlet by wiring inside an existing electrical box connecting directly to the building electrical service and is small enough to fit inside a residential or commercial wall space. The invention includes at least one operative socket in the closed position and at least one additional operative socket in the open position. A socket as used herein means the female receptacle or jack end of any type of connector having at least one hole including but not limited to electrical socket, electrical outlet, coaxial, or any type of data or communication ports or any other connection in which a plug end is inserted into a receptacle to complete an electrical, data or communication connection. It is understood that any opening into which an electrical appliance, data or communication device can be connected is a socket and the use of the term as used herein shall not be considered limiting. The invention comprises a substantially rectangular housing adapted to fit inside a standard electrical box with at least one outwardly open side. The invention further comprises a multi-socket connector having at least two flat adjacent socket surfaces comprising at least one socket opening on each of the two adjacent surfaces. The socket opening in the first and second surfaces are oriented so that the prongs of plugs simultaneously inserted into each of the two sockets do not intersect inside the multi-socket connector. The multi-socket connector is pivotally mounted to the housing so that in the closed position one of the two adjacent socket surfaces is exposed and the second adjacent socket surface is recessed inside the housing. In the pivoted open position of the invention, both the at least one socket openings on the first surface and the at least one socket opening on the second surface are both accessible. The assembly further comprises one or more cover plates which attach to the peripheral flange of the housing and optionally to the closed socket surface. The invention further includes a lock-release button that locks the multi-socket connector in the closed position. The lock release button may be a sliding lock release button that is slid away from the invention to allow the multi-socket connector to pivot into the open position.

The object of the invention is to provide a recessed retractable electrical receptacle assembly with at least one exposed operable socket in the closed position capable of being opened to expose additional operable sockets.

Another object of the invention is to provide a recessed retractable electrical receptacle assembly which is adapted to fit into a standard electrical box which can increase the number of sockets in the same space.

A further object of the invention is to provide a recessed retractable electrical receptacle assembly which comprises both electrical sockets and data communication ports in the same assembly.

Another object of the invention is to provide a recessed retractable electrical receptacle assembly which comprises sockets with either at least one ground fault circuit interrupter (GFCI) or Arc Fault Circuit Interrupter (AFCI).

Yet another object of the invention is to provide a recessed retractable electrical receptacle assembly which when installed maintains substantially the appearance of a typical outlet.

A further object of the invention is to provide a recessed retractable electrical receptacle assembly that has no external wires making it safe and easy to install.

### BRIEF DESCRIPTION OF THE DRAWINGS

The invention will now be described with reference to the drawing in which:

FIG. 1 is an exploded perspective view of the components of one embodiment of the invention.

FIG. 2 is a perspective view showing the multi-socket connector of the invention articulated in the closed position.

FIG. 3 is a perspective view of one embodiment of the invention in the closed position.

FIG. 4 is a perspective view of one embodiment showing the multi-socket connector of the invention in the open position.

FIG. 5 is a perspective view of the one embodiment invention in use in the open position.

FIG. 6 is a top plane view of one embodiment the invention in the open position.

FIG. 7 is a top plane view of one embodiment the multi-socket connector of the invention.

FIG. 8 is a side plane view of one embodiment the invention in the open position.

FIG. 9 is a front plane view of one embodiment the invention.

FIG. 10 is an exploded view of the preferred embodiment of the invention showing the receptacle cover plate, the installation flange cover plate, the multi-socket assembly, the housing and the sliding lock-release button.

FIG. 11 is a perspective view of the multi-socket connector inside the housing with the slide-lock button installed, without the installation flange cover plate and receptacle cover plate installed.

FIG. 12 is a perspective view of the back of the multi-socket connector inside the housing and showing the wire connector on the back of the housing.

FIG. 13 is a detail of the wire connector.

FIG. 14 is exploded view of the invention and an outlet box into which it can be installed.

FIG. 15 is a side view of the long side of the invention installed into an outlet box in the open position.

FIG. 16 is a side view of the width of the invention installed into an outlet box in the open position.

FIG. 17 is a front view of the invention in the open position as it appears after installation into a mounting surface.

### DETAILED DESCRIPTION OF THE PREFERRED EMBODIMENT

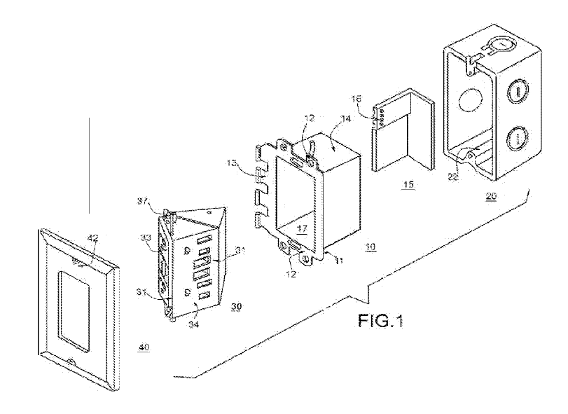

Referring to FIG. 1, an embodiment of the invention is shown in an exploded view. The invention comprises a housing 10 that prevents access to electrical wiring when installed in a standard electrical box 20 while also provides an open space for the multi-socket assembly component to move in and out, a multi-socket connector 30 which has sockets on two adjacent sides, a cover plate 40 and a means for pivoting the multi-socket connector between a closed position and an open position. The invention presented includes an multi-socket connector that has accessible sockets when in the closed position, similar to a standard electrical outlet. When the invention is open, the design of the inventions presents additional sockets (standard electrical, USB, or other). The invention is designed and adapted to fit into a standard electrical box 20 making it retro-fittable to most residential or commercial applications. As used herein, a standard electrical box measures approximately 2″ wide×3″ long with a depth of between 1½″ to 3½″ deep. The preferred standard electrical outlet box is 2″×3″×3½″ and has a volume of 18 cubic inches.

The housing 10 is substantially a rectangular box with at least one open side 17 and sized and adapted to fit into a standard electrical box 20. The housing 10 includes a peripheral flange 11 on the open side 17 of the housing 10. The housing 10 may include one or more hinge barrels 13 on the edge of the open side that does not have the peripheral flange. The hinge barrels are for connecting to the other components of the invention and for providing a pivoting means 18. Any appropriate type of hinge can be used to connect the multi-socket assembly to the housing and provide a pivoting means as described herein.

The peripheral flanges may have one or more bore holes 12 which correspond to the bore holes 22 of a standard electrical box 20. The housing 10 can be connected to the standard electrical box by inserting a screw through the flange bore hole 12 and electrical box bore hole 22.

The invention further provides a multi-socket connector 30 which is sized and adapted to fit into the housing 10. The multi-socket connector 30 is a substantially closed box containing standard electrical connector wiring for connecting electrical and data communication devise male end plugs. The multi-socket connector 30 has at least one socket opening 31 on each of two adjacent surfaces. Any number of multiple socket configurations can be imagined. The configuration shown in FIGS. 1-9 has two GFCI sockets on the exposed surface and two USB sockets on the hidden surface adapted for use in a standard electrical single gang box 20. However, it is intended that the invention encompassed any connector type and includes any standard size electrical box.

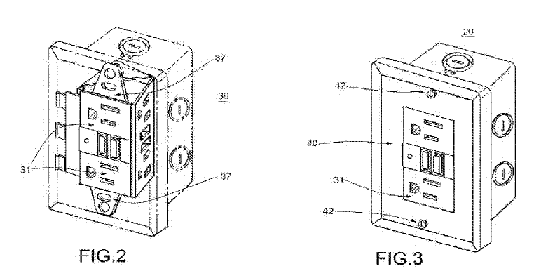

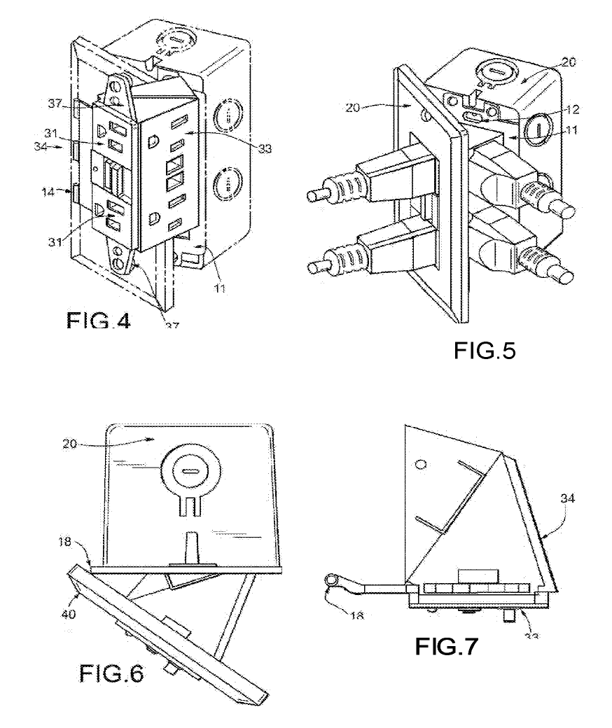

The multi-socket connector has a flat closed position surface 33 adjacent and substantially perpendicular to a flat open position surface 34. As can be seen in FIGS. 2 and 3 the sockets 31 on the closed position surface 33 are exposed and available for use in the closed position. FIGS. 2 and 3 also show that the open position surface 34 is recessed inside the housing 10 in the closed position. As can be seen in FIGS. 4, 5 and 6, the multi-socket connector is adapted to pivotally open to expose the sockets 31 on the open position surface 34. FIGS. 4, 5 and 6 shows that both the sockets 31 on the open position surface 34 and sockets 31 on the closed position surface 33 are available for use only in the open position.

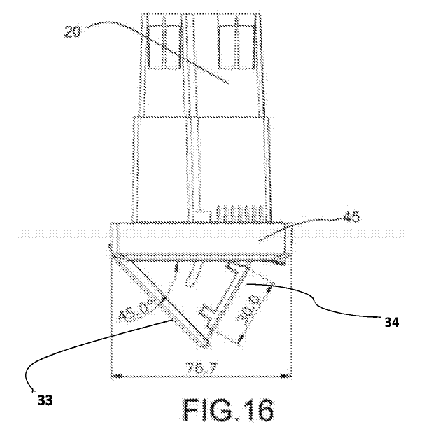

The multi-socket connector 30 is adapted so that the open socket surface 34 clears the housing 10 during the outward pivotal articulation between the closed position as shown in FIGS. 2, 3, 9, 10 and 11 and open position as shown in FIGS. 4, 5, 6, 14, 16, 17 and 18. The relative angle between the multi-socket connector and the closed surface 33 in the open position is preferably less than 90 degrees. Preferably the relative angle between is 45 degrees as shown in FIG. 16. The appropriate angle must be selected to allow the multi-socket connector 30 to clear the housing 10. The angle optimally provides for the proper orientation of the sockets on the closed surface 33 and the adjacent open surface 34 such that the socket bore holes do not intersect inside the multi-socket connector 30 which would cause interference and arcing. The proper angle also allows the device plugs to lie flat against the closed surface 33 and open surface 34 as can best be seen in FIG. 5. The sockets as shown in the FIGS. 1-17 are oriented horizontally relative to the width of the housing which prevents intersection of the sockets bores inside the multi-socket connector 30.

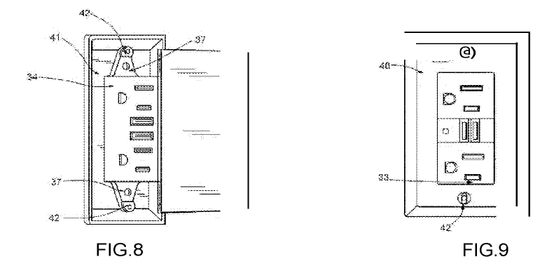

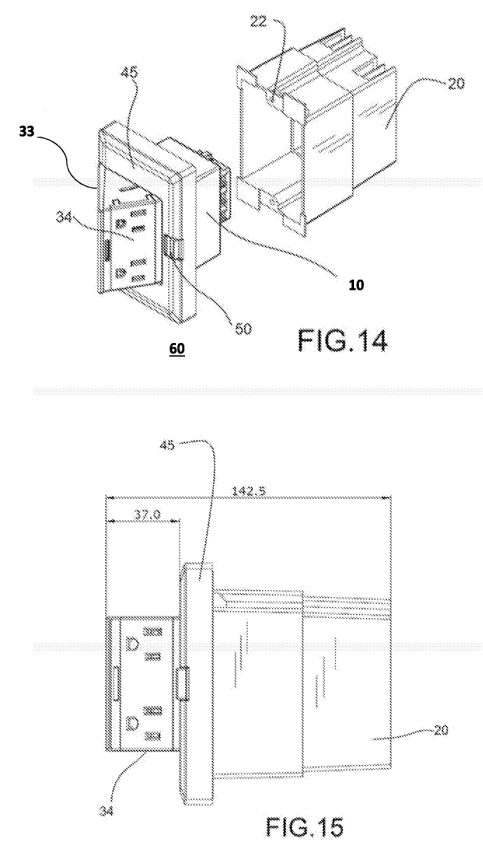

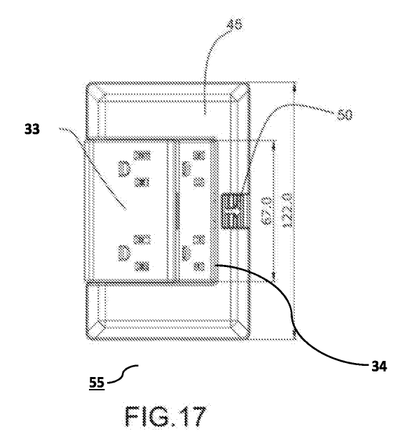

The multi-socket connector may optionally include at least one connection tab 37 for connecting the multi-socket connector 30 to the cover plate 40. The tab 37 of the multi-socket connector 30 may be connected to the cover plate 40 by any preferable connecting means such adhesive, screws, rivets, male and female snap connector and the like. As seen in FIGS. 3 and 9, the cover plate 40 forms a substantially flush border around the exposed multi-socket connector closed surface 33 of the multi-socket connector 30 forming a framed multi-socket connector 55. FIG. 8 shows the multi-socket connector 30 attached to cover plate backside 41 by the tabs 37 in the open position of the invention. FIG. 11 shows multiple snap connections 13 on the peripheral flange 11 which correspond to snap connections on the flange cover plate 45. When the flange cover is attached to the peripheral flange a framed multi-socket connector 55 is formed as shown in FIGS. 14 and 17.

In the preferred embodiment, the multi-socket connector 30 has at least one pivoting means 18 such as a barrel hinge as shown in the FIGS. 1, 2, 4 and 7 or any other appropriate pivoting mechanism along a peripheral edge. In the case of a barrel hinge, the hinge barrels of the multi-socket connectors 30 are capable of being lined up with the hinge barrels 13 of the housing 10 to form a substantially continuous linear barrel for accepting a hinge pin 44 to create a hinge. The hinge connects the multi-socket connector 30 to the housing 10 and allows the multi-socket connector 30 to pivot outwardly away from the housing 10 from the closed position to the open position.

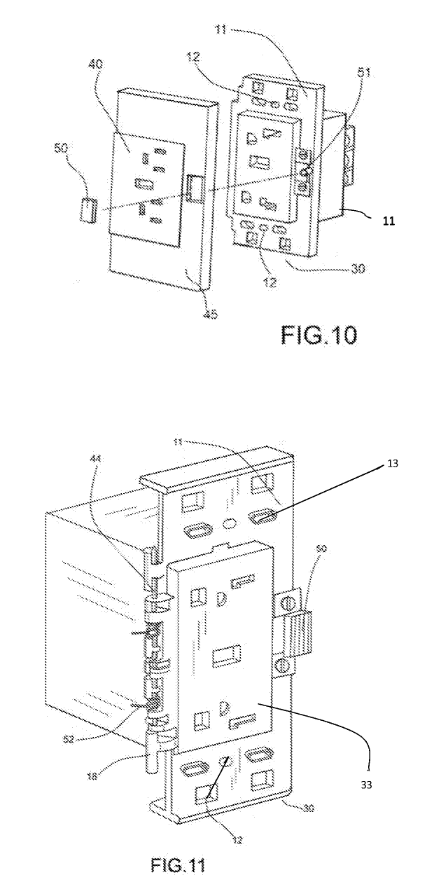

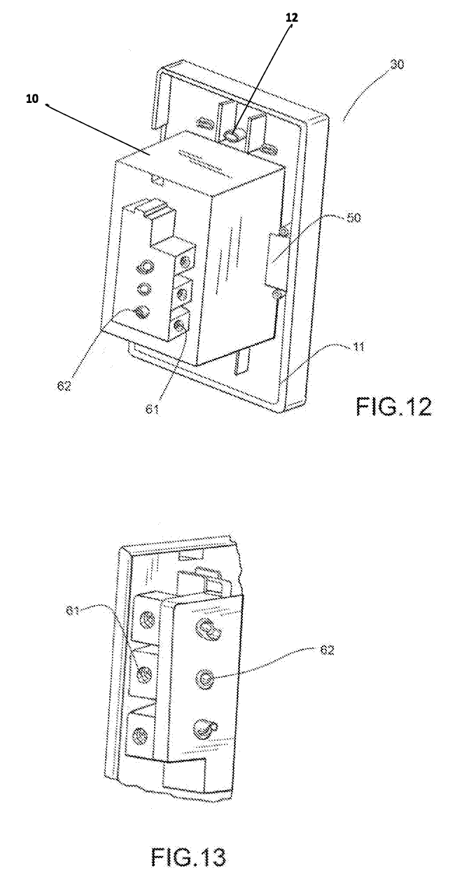

Referring now to FIG. 10, which shows the preferred embodiment as a combined multi-socket connector and housing unit with removable receptacle cover plate 40, removable installation flange cover plate 45 and removable lock-release button 50. The housing 10 is rectangular box with a width, length, and depth. The housing has a back and four (4) sides and is open to the front. In the preferred embodiment, the housing is between 2″ and 3″ deep×1″ to 2″ wide×2″ and 4″ wide. The open front has two parallel width peripheral edges and two parallel length peripheral edges which is surrounded on the two width edges and one length edge by a peripheral installation flange and on one length edge is one part of a hinge. The peripheral installation flange barrel portion 18 is shown in FIG. 11. The multi-socket connector 30 is connected to the housing 10 by a pin 44 and barrel hinge 18 along one of the length peripheral edges of the housing 10 and one of the length peripheral edges of the multi-socket assembly 30. A least one spring 52 is attached to the barrel pin for providing spring force to facilitate opening the multi-socket assembly. The peripheral installation flange of the housing 11 is further shown comprising installation bore holes 12 for connecting the housing to a electrical outlet box. FIG. 10 further shows the removable receptacle cover plate 40, removable installation flange cover plate 11 and removable lock-release button 50. The housing may further comprise a spring-loaded lock-release on the peripheral installation flange which may optionally be opposite the barrel hinge. The housing comprises a wire connector shown in FIGS. 12 and 13 which protrudes from the housing back. The wire connector comprises intersecting screw bore holes 61 and wire holes 62 on perpendicular sides. Inside each wire bore hole is an electrical contact connected to the multi-socket assembly internal receptacle wiring. In this preferred embodiment of the invention, the invention is installed by first removing the removable installation flange cover plate 45 and removable lock-release 50. Optionally, the removable receptacle cover plate may be removed as in shown in FIGS. 10 and 11 and may be optionally switched for optional color choices. The combined multi-socket assembly housing unit 60 is first wired to the electrical service wiring through the electrical box. The electrical service wiring which includes a ground or protective wire, a neutral wire and a single phase or “hot” wire are stripped of the protective covering to expose a sufficient amount of bare wire. The bare wires are inserted into the corresponding wire bore holes 62 and screws inserted into the screw bore holes 61 are tightened so that the electrical service wiring makes tight connections with the electrical contacts in the wire bore holes 62. Once wired, the combined multi-socket assembly housing unit is inserted into, and connected to the electrical outlet box by inserting screws through the installation bore holes 12 in the peripheral installation flange 11. The lock release button 50 is snapped onto the snap connection on the spring-loaded tab on the peripheral installation flange as shown in FIG. 11. Likewise, the receptacle cover plate 40 and installation flange cover plate 45 are snapped into place by connecting corresponding male and female snap connectors on the peripheral installation flange and closed position receptacle surface and the back of the installation flange cover plate 45 and receptacle cover plate. The installation flange cover plate 45 surrounds the closed position receptacle surface on the top and bottom widths and the length opposite the hinge 18 of the peripheral installation flange 11. The installation flange cover plate is sufficiently deep to completely cover the peripheral installation flange 11 and makes contact with the mounting surface. Once the installation flange cover plate 45 is snapped in place, it is substantially flush with the receptacle surface in the closed position with the installed receptacle cover plate. Preferably, the installation flange cover plate 45 is between 3″ and 4″ wide and 4″ and 5″ wide. Most preferably, the width of the installation flange cover plate is 3 1/64″ a length of 4 51/64″. As can be seen in FIG. 14-17, the installation flange cover plate 45 is stationery once installed and does not pivot when the multi-socket assembly is in the open position. The protrusion from the installation cover plate and the intersection of the open and closed receptacle surfaces in the open position is less than 2″ and preferably less than 1½″. As can be in FIG. 15, the distance from the intersection of the open and closed receptacle surface is preferably 37 mm. The width of the open and closed receptacle surface is 67 mm. The installation flange cover plate 45 preferably has a length of 122 mm and a width of 76.7 mm.

The present invention is not intended to be limited to the embodiments described herein, but is intended to encompass any and all embodiments within the scope of the following claims.

1. A recessed retractable electrical receptacle assembly comprising:
a closed position and an open position;
a rectangular housing adapted to fit inside a standard electrical box recessed into a mounting surface wherein said housing comprises a back side, four sides and one open side wherein a peripheral installation flange surrounds three sides of said open side and a housing hinge edge on one of said open side wherein said housing back side further comprises a wire connector comprising internal electrical contacts for connecting to electrical service wiring;
a multi-socket connector adapted to fit inside said housing through said one open side and having a hinge edge for connecting to said housing hinged edge and wherein said multi-socket connector comprises a closed position socket surface and an open position socket surface adjacent to said closed position socket surface wherein the closed position socket surface and open position socket surface each comprise at least one electrical socket and wherein said at least one electrical socket is internally wired to said internal electrical contacts in said wire connector;
an installation flange cover plate attachable to said peripheral installation flange said installation flange cover plate surrounding three sides of said closed position socket surface; and
a hinge connecting said housing and said multi-socket connector for articulating said multi-socket connector outwardly away from said housing between said closed position and said open position wherein said open position socket surface is recessed in said housing in said closed position and said closed position socket surface and open position socket surface are exposed in said open position.

2. The recessed retractable electrical receptacle assembly of claim 1, wherein said hinge is a barrel and pin hinge.

3. The recessed retractable electrical receptacle assembly of claim 1, wherein said housing is no larger than 2 inches wide and 3 inches long and 3½ inches deep.

4. The recessed retractable electrical receptacle assembly of claim 1, wherein the protrusion of the closed socket surface from said installation cover plate in said open position is less than 2 inches.

5. The recessed retractable electrical receptacle assembly of claim 1, wherein the wire connector comprises wire bore holes for inserting electrical surface wires and intersecting screw bore holes for inserting screws for connecting the electrical service wiring to said internal electrical contacts.

6. The recessed retractable electrical receptacle assembly of claim 1, wherein said flange cover plate is removable.

7. The recessed retractable electrical receptacle assembly of claim 1, further comprising lock-release button.

8. The recessed retractable electrical receptacle assembly of claim 7, wherein said lock-release button is a slide release.
